(19) United States
(12) Patent Application Publication
(10) Pub. No.: US 2002/0012790 A1
(43) Pub. Date: Jan. 31, 2002

(54) HYDROPHILIZED POROUS SUBSTRATE FOR USE IN LITHOGRAPHIC PRINTING PLATES

(76) Inventors: AJAY SHAH, LIVINGSTON, NJ (US); MY T. NGUYEN, KIRKLAND (CA); KEN-ICHI SHIMAZU, BRIARCLIFF MANOR, NY (US)

Correspondence Address: WILLIAM P HAUSER, RATNER & PRESTIA, P O BOX 7228, WILMINGTON, DE, 19803

(21) Appl. No.: 09/243,994

(22) Filed: Feb. 4, 1999

(51) Int. Cl. B32B 5/16; B32B 15/08

(52) U.S. Cl. 428/331; 428/325; 428/341; 428/463; 428/457; 428/483; 428/514

(57) ABSTRACT

Hydrophilic substrates which are useful in preparing lithographic printing plates, contain a hydrophilic layer adhered to a sheet support. The hydrophilic layer contains as a key component about 30 weight % or more of a clay, and typically contains a crosslinked water-soluble binder; colloidal silica; and amorphous silica to provide a dry coating weight of about 5 g/m² or more. The hydrophilic layer may be porous and such porous hydrophilic substrates are particularly useful for preparing lithographic printing plates by ink jet printing.

### BACKGROUND OF THE INVENTION

1. Field of the Invention

This invention relates to lithographic printing plates. More particularly, this invention relates to hydrophilic substrates used in lithographic printing plates.

2. Description of Related Art

Conventional lithographic printing plates contain an oleophilic image applied to a hydrophilic underlayer. A typical means for forming a lithographic image on a hydrophilic substrate, such as a coated paper stock, is by typing, writing or drawing directly on the surface of the coated paper stock using a suitable ink which forms an oleophilic image surface. Alternatively, conventional sensitized lithographic printing plates typically have a radiation sensitive, oleophilic image layer coated over a hydrophilic underlayer. The plates are imaged by imagewise exposure to actinic radiation to produce exposed areas which are either soluble (positive working) or insoluble (negative working) in a developer liquid. During development of the imaged plate, the soluble areas are removed by the developer liquid from underlying hydrophilic surface areas to produce a finished plate with ink receptive oleophilic image areas separated by complimentary, fountain solution receptive hydrophilic areas. During printing with either of the two types of litho plates, a fountain solution and ink are applied to the imaged plate. The fountain solution is applied to the imaged plate to wet the hydrophilic areas, so as to insure that only the oleophilic image areas will pick up ink for deposition on the paper stock as a printed image.

The hydrophilic underlayer may be the surface of the supporting substrate, such as the anodized roughened surface of an aluminum substrate, or it may be a separate layer adhered to a substrate with little or no hydrophilicity. In either instance it is crucial that the hydrophilic underlayer be receptive to the aqueous fountain solution so as to prevent adherence of ink leading to scumming and other such defects during the lithographic printing process. Illustrative of separate hydrophilic underlayers are those disclosed in Shaw, U.S. Pat. No. 4,046,946 and Cliver et al., UK Patent Specification 1,419,512.

Shaw, U.S. Pat. No. 4,046,946 discloses a single coat paper based lithographic printing plate. A coated layer functions both as a barrier coat and a face coat for paper stock to provide a lithographic printing surface. The paper based lithographic printing plate may be imaged in a known manner with typed, written, or drawn copy material to be reproduced. The disclosed lithographic printing surface comprises a coating of positively charged silica and insolubilized hydrophilic polymer. The coating also contains a non-flocculating pigment and a resinous binder that is cationic and/or non-ionic. Non-flocculating pigments disclosed include neutral clay, acid clay, silica, talc, or treated clays.

Cliver et al., UK Patent Specification 1,419,512, discloses a presensitized lithographic material which comprises a support, a hydrophilic layer and over the hydrophilic layer, a light sensitive layer which may be composed of a silver halide material or a positive or negative working polymeric material. The hydrophilic layer contains polyvinyl alcohol and/or other synthetic polymer latex as a binder; and the hydrolysis product of an alkyl orthosilicate; and may also contain colloidal silica fumed silica particles, fumed alumina particles or may contain particles having an average diameter of 200 Å which are particles of titanium dioxide or other heavy metal oxide or particles of alumina or clay with fumed silica and colloidal silica being preferred. Cliver et al. discloses that the total thickness of the hydrophilic layer is low, and in Example 1, coats a support at a rate of 20 cc/m² with a hydrophilic layer coating solution.

While advances have been made, there continues to be a need for improved hydrophilic layers for use in lithographic printing plate substrates, and particularly for use in preparing lithographic plates by ink jet printing.

### SUMMARY OF THE INVENTION

These needs are met by the hydrophilic substrate of this invention which comprises

(a) a sheet support; and

(b) a hydrophilic layer adhered to a surface of the sheet support, wherein the hydrophilic layer comprises about 30 weight % or more of a clay based on the weight of the hydrophilic layer, and wherein the hydrophilic layer has a coating weight of about 5 g/m² or more.

### DETAILED DESCRIPTION OF THE INVENTION

The present invention relates to preparation of a hydrophilic surface for lithographic printing, on a metal or polyester support which is overcoated with a hydrophilic layer. The hydrophilic layer of this invention is prepared from a coating composition containing a clay, a silica, a surfactant, a binder resin and a crosslinker. The main component clay has unusual water absorption characteristics and has extremely fine particles which yield very large specific surface areas that are physically sorptive. The porosity of the hydrophilic surface can be modified by selecting particle size of the clay minerals. Typically porosity and roughness play a key roll in the optimum performance of the substrate for lithographic printing. High porosity is particularly important when the oleophilic image is applied to the hydrophilic layer by ink jet printing.

Contact angle is an indicator of the hydrophilicity of a surface. Typically a lower contact angle for the substrate means that the imaged lithographic plate has good ink-water balance on press, has good ink receptivity only in oleophilic image areas with no scumming, and has fast roll up on the press. Contact angles were measured on a video contact angle (VCA) system manufactured by Advanced Surface Technology, Inc. A typical experiment is to measure the contact angle of a water droplet surrounded by magic oil. An uncoated polyester support and a degreased aluminum support have contact angles of 94 and 90 degrees respectively. When these substrates are coated with the hydrophilic layer of this invention, the contact angle is dramatically reduced to 49 and 40 degrees, respectively.

Sheet Support

Any dimensionally stable sheet material may be used to support the lithographic plate structure of this invention. Thus the support may be polymeric films such as polyester films; metal sheets such as aluminum; paper product sheets; and the like. Each of these support types may be coated with ancillary layers to improve interlayer adhesion; thermal isolation, particularly for metal supports; and the like.

A preferred polymeric support is a sheet of polyester film such as polyethylene terephthalate, although other polymeric films and composites may also be used such as polycarbonate sheets; and the like.

A preferred metal support is aluminum particularly for such plates having long press life. The support surface may be treated or sub-coated with a material which provides a hydrophilic character to the support surface for use with a fountain solution. Thus an aluminum support may be electrochemically treated to provide a grained surface and enhance hydrophilicity of the surface for use with fountain solutions.

Supports can have any desired thickness that would be useful for a given printing application, and to sustain the wear of a printing press and thin enough to wrap around a printing form, for example from about 100 to about 500 μm in thickness. A preferred polymeric support composed of polyethylene terephthalate can have a thickness from about 100 to about 200 μm.

Hydrophilic Layer

The hydrophilic layer comprises about 30 weight % or more of a clay, based on the weight of the hydrophilic layer. The hydrophilic layer has a coating weight of about 5 g/m² or more, typically about 10 g/m² or more, and preferably, about 12 g/m² or more.

In one embodiment of this invention, the hydrophilic substrate has a porous hydrophilic layer, as determined by acoustic measurements using an EST surface sizing tester commonly used for determination of the wetting and absorption phase of a porous substrate by ultrasonic methods. Such acoustic studies measure the rate of penetration of water (or water-based ink) in the hydrophilic substrate. The rate of penetration is also a measure of the degree of porosity of the hydrophilic layer.

By “porous hydrophilic layer” is meant a hydrophilic layer having a water, or water-based ink, absorption rate that produces an attenuation of at least 5% of the original acoustic signal after 5 seconds, as determined using a commercially available EST surface tester, such as that manufactured by Muetex Analytic, Inc., Marietta, Ga. Such studies indicate that the hydrophilic substrates of the present invention have faster penetration rate than commercially available hydrophilic substrates. High penetration rate (high porosity) and low contact angle play a key role in the optimum performance of a hydrophilic substrate for the ink jet printing application; whereas low penetration rate (low porosity) and low contact angle of hydrophilic substrates are suitable for presensitized lithographic printing plate applications.

Roughness is an additional key factor for optimum performance as a lithographic printing plate substrate. The hydrophilic coatings of this invention typically have a roughness of Ra 0.5-1.0 μm, preferably Ra 0.6-0.8 μm, for ink jet applications; and a roughness of Ra 0.8-1.1 μm for presensitized plate applications.

A typical hydrophilic layer of this invention contains a clay and a crosslinked hydrophilic binder which is a product of a reaction of a water-soluble binder with a hardening agent. In a preferred embodiment this layer also includes one or more colloidal silicas, amorphous silicas, and surfactants.

Useful clays may be either synthetic or naturally occurring materials. Clays are predominantly composed of hydrous phyllosilicates, referred to as clay minerals. These clay minerals are hydrous silicates of Al, Mg, K, and Fe, and other less abundant elements. Such clays include, but are not limited to, kaolin (aluminum silicate hydroxide) which is to be understood to include the minerals kalinite, dickite, nacrite and halloysite-endellite. Other useful clays include, but are not limited to, the serpentine clays (including the minerals chrysotile, amersite, cronstedite, chamosite and garnierite), the montmorillonites (including the minerals beidellite, nontronite, hextorite, saponite and sauconite), the illite clays, a glauconite, a chlorite, a vermiculite, a bauxite, a attapulgite, a sepiolite, a palgorskite, a corrensite, an allophane, an imogolite, a diaspore, a boehmite, a gibbsite, a cliachite, and mixtures thereof. In addition, synthetic clays such as laponites and hydrotalcites, (a chemical composition comprising magnesium aluminum hydroxy carbonate hydrate) may be used. Kaolin is preferred. Mixtures of these clays can also be used if desired. Such clays can be obtained from a number of commercial sources including for example, ECC International and Southern Clay Products. Examples of commercially available clays include: TEX 540 clay, (a mixture of metal oxides having aluminum oxide 38.5% and silicon oxide 45.3%, less than 1% each of sodium, titanium, calcium, and an average particle size of 4-6 μ; ECC International); kaolin (china)clay, (a mixture of metal oxides having aluminum oxide 26% and silicon oxide 25%, and an average particle size of 0.4 μ; Aldrich); kaolin clay, (a mixture of metal oxides having aluminum oxide 34% and silicon oxide 51%, and an average particle size of 1 μ; Across); and the like.

Water-soluble binders which are useful in preparing the porous hydrophilic layer, include both inorganic and organic binder materials such as, but not limited to, gelatin (and gelatin derivatives known in the photographic art), water-soluble cellulosic materials (for example hydroxypropylcellulose, hydroxyethylcellulose, hydroxypropylmethylcellulose and carboxymethylcellulose), water-soluble synthetic or naturally occurring polymers (for example a polyvinyl alcohol, poly(vinyl pyrrolidones), polyacrylamides, water absorbent starches, dextrin, amylogen, and copolymers derived from vinyl alcohol, acrylamides, vinyl pyrrolidones and other water soluble monomers), gum arabic, agar, algin, carrageenan, fucoidan, laminaran, cornhull gum, gum ghatti, guar gum, karaya gum, locust bean gum, pectin, and the like. Cellulosic materials are preferred. Mixtures of any of these materials can be used for the preparation of the layer. As used herein the term “water-soluble” is intended to mean that the material can form a solution in water having 1 weight % or greater of the material. A preferred cellulosic binder of this type is Methocel K100LV which is 5% hydroxypropyl methylcellulose aqueous solution, Dow Chemical.

One or more hardening agents may be used to produce the crosslinked hydrophilic binder in the hydrophilic layer. Useful hardening agents include, but are not limited to, tetraalkoxysilanes (such as tetraethoxysilane and tetramethoxysilane) and silanes having two or more hydroxy groups, alkoxy groups, acetoxy groups, (including but not limited to 3-aminopropyltrihydroxysilane, glycidoxypropyltriethoxysilane, 3-aminopropylmethyidihydroxysilane, 3-(2-aminoethyl)aminopropyl-trihydroxysilane, N-trihydroxysilylpropyl-N, N, N-trimethyl-ammoniumchloride, trihydroxysilylporopanesulfonic acid and salts thereof). Of these hardening agents 3-aminopropyltrihydroxysilane, glycidoxypropyltriethoxysilane or tetramethoxysilane are preferred.

When colloidal silica is present in the hydrophilic layer, it can be obtained from a number of commercial sources, for example as Ludox SM-30 (DuPont) and as Nalco® 2326 (Nalco).

The porous hydrophilic layer may contain one or more surfactants used in applying the layer to the substrate. Useful coating surfactants include CT-121 (Air Products), Zonyl® FSN nonionic surfactant (DuPont), Olin 10G (Olin Corporation) and Fluorad® FC431 nonionic surfactant (3M).

Additional materials useful in the porous hydrophilic layer include fillers such as amorphous silica particles (e.g., about 5 μm in average size) to provide a roughness to the surface that eventually is used for printing. Typically, amorphous silica improves the coatability of the hydrophilic layer onto the support sheet.

Although the hydrophilic layer contains about 30 weight % or more of the clay, the layer typically contains 30-80 wt. % clay; 15-50 wt. % colloidal silica; 2-15 wt. % water soluble polymeric binder; 1-10 wt. % hardening agent; 0.01-1 wt. % surfactant; and 0.1-10 wt. % of amorphous silica. Preferably, the porous hydrophilic layer contains 50-70 wt. % clay; 20-40 wt. % colloidal silica; 5-12 wt. % water soluble polymeric binder; 1-5 wt. % hardening agent; 0.1-0.5 wt. % surfactant; and 1-3 wt. % of amorphous silica. In the most preferred embodiment the porous hydrophilic layer is formed from about 62 wt. % clay; about 29 wt. % colloidal silica; about 8 wt. % water soluble polymeric binder; about 4 wt. % hardening agent, all percentages being based on the total dry weight of the layer. The remainder of the layer can be composed of the other addenda described above.

The materials in the hydrophilic layer can be applied to the support in any suitable manner using conventional coating equipment and procedures. Upon drying, the coated hydrophilic layer typically has a dry coating weight of about 10 g/m² or more and preferably about 12 g/m² or more. Typically, the coating weight of the hydrophilic layer is between about 10 g/m² and about 20 g/m² , and preferably, between about 12 g/m² and about 16 g/m².

The hydrophilic substrate of this invention will now be illustrated by the following examples, which illustrate, but do not limit, the invention. In the following examples the term “wt. %” means the weight % of the component designated based on the total weight of components, i.e., “solids”, exclusive of water or any solvents used to disperse or coat the mixture.

### EXAMPLES

### Example 1

A porous hydrophilic layer on a sheet substrate was prepared as follows: A hydrophilic coating mixture was prepared by mixing 240 g (26 wt %) Ludox SM30 (30% colloidal silica aqueous solution; DuPont), 408 g (7.5 wt. %) Methocel K100LV (5% hydroxypropyl methylcellulose aqueous solution; Dow), 144 g (51 wt. %) TEX 540 clay, (a mixture of metal oxides having aluminum oxide 38.5% and silicon oxide 45.3%, less than 1% each of sodium, titanium, calcium, and an average particle size of 4-6 μ; ECC International), 32 g (11.5 wt. %) Syloide 7000 (amorphous silica; W.R. Grace), 12 g (4 wt. %) surfactant CT-121 (Air Products), and 240 g water. This coating mixture was mixed in a shear mixer for 15 minutes and then passed through an Eiger horizontal mill filled with zirconia beads for a total of four passes. Tetramethoxysilane (8 mL) was added to 950 g of the mixture, which was subsequently coated at 50 mL/m² onto either a grained aluminum sheet or a subbed polyethylene terephthalate support using a conventional slot coater.

After drying in an oven at 100-120° C. for 5-10 minutes, the dry coatings were then hardened at 100° C. for 30 minutes. The hydrophilic layer had a dry coating weight of 14-16 g/m², and a surface roughness of 0.6-0.8 μm. Acoustic studies (Example 4) of the hydrophilic layer indicated that substantial water penetration occurred, and that the layer therefore was considered porous.

### Example 2

A hydrophilic layer on a sheet substrate was prepared as follows: A hydrophilic coating mixture was prepared by mixing 160 g (18.6 wt. %) Ludox SM30 (30% colloidal silica aqueous solution; DuPont), 408 g (7.9 wt. %) Methocel K100LV (5% hydroxypropyl methylcellulose aqueous solution; Dow), 80 g (31 wt. %) Kaolin (china)clay, (a mixture of metal oxides having aluminum oxide 26% and silicon oxide 25%, and an average particle size of 0.4 μ; Aldrich), 80 g (31 wt. %) Kaolin clay, (a mixture of metal oxides having aluminum oxide 34% and silicon oxide 51%, and an average particle size of 1 μ; Across), 16 g (6.2 wt. %) Syloid® 7000 (amorphous silica; W.R. Grace), 13 g (5 wt. %) surfactant CT-121 (Air Products), and 319 g water. This coating mixture was mixed for 48 hours in a ceramic ball mill with ceramic shots (weight of shots, 1614 g). Tetramethoxysilane (8 mL) was added to 950 g of the mixture, which was subsequently coated at 50 mL/m² onto either a grained aluminum sheet or a subbed polyethylene terephthalate support using a #5 wire-wound rod.

The coatings were dried in an oven at 100-120° C. for 5-10 minutes, and the dry coatings were then hardened at 100° C. for 30 minutes. The dry hydrophilic layer had a coating weight of 14-16 g/m², and a surface roughness of 0.9-1.1 μm. Acoustic studies (Example 4) of the hydrophilic layer indicated that there was little or no water penetration, indicating that the substrate is substantially non-porous. However, an electron micrograph of the surface of the hydrophilic layer at 5 KV electrons and 2000 magnification revealed that the surface is micro-porous having pores which are a fraction of a micrometer.

### Example 3

A porous hydrophilic layer on a sheet substrate was prepared as follows: A hydrophilic coating mixture was prepared by mixing 1200 g (25.7 wt. %) Ludox SM30 (30% colloidal silica aqueous solution; DuPont), 2040 g (7.3 wt. %) Methocel K100LV (5% hydroxypropyl methylcellulose aqueous solution; Dow), 720 g (51.3 wt. %) TEX 540 clay, (a mixture of metal oxides having aluminum oxide 38.5% and silicon oxide 45.3%, less than 1% each of sodium, titanium, calcium, and an average particle size of 4-6 μ; ECC International), 160 g (11.4 wt. %) Syloid® 7000 (amorphous silica; W.R. Grace), 60 g (4.3 wt. %) surfactant CT-121 (Air Products), and 1200 g water. This coating mixture was mixed in a high shear mixer for 30 minutes and then passed through an Eiger horizontal mill filled with zirconia beads for a total of three passes. The resulting mixture was then further diluted with 9780 g water and 15 g Zonyl® FSN nonionic surfactant (DuPont) and thoroughly mixed to provide about 15 kg of coating solution. Tetramethoxysilane (70 mL) was added to 15 kg of the mixture, which was subsequently coated onto a degreased aluminum sheet. The aluminum sheet was degreased by rinsing the bare aluminum sheet with 10% sodium hydroxide solution followed by a water rinse.

After drying in an oven at 100-120° C. for 5-10 minutes, the dry coating was then hardened at 100° C. for 30 minutes. The hydrophilic layer had a dry coating weight of 14-16 g/m², and an average surface roughness of 0.6-0.8 μm. Acoustic studies of the hydrophilic layer indicated that substantial water penetration occurred and that the layer therefore was considered porous.

### Example 4

Acoustic attenuation measurements were carried out on two commercially available substrates and the substrates of Examples 1 and 2. Acoustic attenuation was determined using a commercially available EST Surface Tester (Muetex Analytic, Inc., Marietta, Ga.). An acoustic emitter and receiver are placed on opposite sides of a container filled with water, and a continuous acoustic signal transmitted from the emitter to the receiver. The substrate is placed in the container perpendicular to the acoustic signal transmission direction. The decrease, if any, of acoustic signal strength is measured as a function of time. A decrease in signal strength indicates penetration of the water into the interior of the hydrophilic layer. A “porous hydrophilic layer” has a water, or water-based ink, absorption rate which results in an attenuation of at least 5% of the original acoustic signal after 5 seconds, as determined using a commercially available EST surface tester.

The following substrates were examined: Substrate A—commercially available hydrophilic substrate Omega Plus II (Autotype International); Substrate B—commercially available hydrophilic substrate Myraid II (Xante Corp.); Substrate C—substrate of Example 1; Substrate D—substrate of Example 2. Results are shown in the following Table.

| Substrate | Acoustic attenuation |
|---|---|
| A | <3% in 60 seconds |
| B | <3% in 60 seconds |
| C | 81% at 1 second |
| D | <10% in 60 seconds |

Those skilled in the art having the benefit of the teachings of the present invention as set forth above can effect numerous modifications thereto. These modifications are to be construed as being encompassed within the scope of the present invention as set forth in the appended claims.

What is claimed is:

1. A hydrophilic substrate comprising
(a) a sheet support; and
(b) a hydrophilic layer adhered to a surface of the sheet support, wherein the hydrophilic layer comprises about 30 weight % or more of a clay based on the weight of the hydrophilic layer, and wherein the hydrophilic layer has a coating-weight of about 5 g/m² or more.

2. The hydrophilic substrate of claim 1 wherein the sheet support is a dimensionally stable, polymeric sheet, a metal sheet, a paper sheet, or a laminate thereof.

3. The hydrophilic substrate of claim 2 wherein the sheet support is a polyethylene terephthalate film.

4. The hydrophilic substrate of claim 2 wherein the sheet support is an aluminum plate.

5. The hydrophilic substrate of claim 1, wherein the hydrophilic layer is porous.

6. The hydrophilic substrate of claim 1, wherein the hydrophilic layer contains from about 50 weight % to about 70 weight % of the clay.

7. The hydrophilic substrate of claim 1 wherein coating weight of the hydrophilic layer is about 10 g/m² or more.

8. The hydrophilic substrate of claim 1 wherein the hydrophilic layer further comprises a crosslinked water-soluble binder.

9. The hydrophilic substrate of claim 8 wherein the water-soluble binder is a gelatin, a gelatin derivative, a cellulosic material, a vinyl pyrrolidone polymer, an acrylamide polymer, a polyvinyl alcohol, an agar, an algin, a carrageenan, a fucoidan, a laminaran, a gum arabic, a cornhull gum, a gum ghatti, a guar gum, a karaya gum, a locust bean gum, a pectin, a dextran, a starch or a polypeptide.

10. The hydrophilic substrate of claim 8 wherein a residue of a hardening agent is present and the hardening agent is a silane having two or more hydroxy groups, alkoxy groups, acetoxy groups, or a combination thereof.

11. The hydrophilic substrate of claim 10 wherein the hardening agent is aminopropyltriethoxysilane, glycidoxypropyltriethoxysilane, or tetramethoxysilane.

12. The hydrophilic substrate of claim 1 wherein the clay is a kaolin, a serpentine, a montmorillonite, an illite, a glauconite, a chlorite, a vermiculite, a bauxite, an aftapulgite, a sepiolite, a palgorskite, an allophane, an imogolite, a diaspore, a boehmite, a gibbsite, a cliachite, a laponite, a hydrotalcite, or any mixture thereof.

13. The hydrophilic substrate of claim 1 wherein the clay is a kaolin clay.

14. The hydrophilic substrate of claim 1 wherein the hydrophilic layer further comprises colloidal silica.

15. The hydrophilic substrate of claim 1 wherein the hydrophilic layer further comprises amorphous silica.

16. The hydrophilic substrate of claim 1 wherein the hydrophilic layer has a surface roughness Ra of about 0.5 to about 1.0 μm.

17. The hydrophilic substrate of claim 1 wherein the hydrophilic layer has a surface roughness Ra of about 0.8 to about 1.1 μm.

18. The hydrophilic substrate of claim 1 wherein the hydrophilic layer consists essentially of:
(a) a clay;
(b) a crosslinked water-soluble binder;
(c) a residue of a hardening agent;
(d) a colloidal silica;
(e) amorphous silica; and,
(f) a surfactant.

19. The hydrophilic substrate of claim 18 wherein the hydrophilic layer has a surface roughness Ra of about 0.6 to about 0.8 μm.
